(19) United States
(12) Patent Application Publication
(10) Pub. No.: US 2012/0282482 A1
(43) Pub. Date: Nov. 8, 2012

(54) Method and Device for Producing a Half-Shell Part

(75) Inventors: Thomas Flehmig, Ratingen (DE); Konstantinos Savvas, Oberhausen (DE)

(73) Assignee: ThyssenKrupp Steel Europe AG, Duisburg (DE)

(21) Appl. No.: 13/524,545

(22) Filed: Jun. 15, 2012

Related U.S. Application Data
(63) Continuation of application No. PCT/EP2010/069794, filed on Dec. 15, 2010.

(30) Foreign Application Priority Data
Dec. 17, 2009 (DE) 102009059197.4

(51) Int. Cl. B21D 24/16; B32B 15/01

(52) U.S. Cl. 428/603; 72/331

(57) ABSTRACT

The invention relates to a method for producing a half-shell part with a drawing punch and a drawing die. The object of providing a method for the process-reliable and cost-effective production of highly dimensionally stable half-shell parts is achieved in that, in a single work step, the drawing punch is advanced into the drawing die, a sheet metal blank is preformed into a sheet metal raw part with at least one base section, at least one frame section and optionally a flange section, wherein during the preforming with the drawing punch a material excess is introduced either into the base section and the frame section or into the optional flange section of the sheet metal raw part, and the sheet metal raw part is finished to form a half-shell part and calibrated.

### CROSS-REFERENCE TO RELATED PATENT APPLICATIONS

This patent application is a continuation of PCT/EP2010/069794, filed Dec. 15, 2010, which claims priority to German Application No. 102009059197.4, filed Dec. 17, 2009, the entire teachings and disclosure of which are incorporated herein by reference thereto.

### FIELD OF THE INVENTION

The present invention relates to a method for producing a half-shell part with a drawing punch and a drawing die. A device for producing a half-shell part with a drawing punch and a drawing die as well as a half-shell part that can be produced by the said method are also the subject matter of the invention.

### BACKGROUND OF THE INVENTION

In automobile construction closed or open hollow profiles are normally used as structural elements. These are increasingly composed of half-shell parts, whose cross-sections and material thicknesses have to be adapted specifically to the respective application.

To produce half-shell parts, sheet metal blanks are typically deep drawn. During the deep drawing stresses are inevitably introduced into the half-shell parts, which lead to an elastic recovery after the finishing stage. However, the elastic recovery of the half-shell parts complicates for example the accurate positioning of the half-shell parts in a die for welding the half-shell parts to form a closed hollow profile.

In DE 10 2007 059 251 A1 it has therefore been proposed first of all to preform in a first device a sheet metal raw part from the sheet metal blank, which raw part has in the base section a material excess compared to the half-shell part to be produced. This sheet metal raw part is then finished in a further device to form a half-shell part, wherein the material excess present in the base section is displaced into the other sections of the sheet metal raw part. In this way the extent of the elastic recovery can be reduced. However, two devices and two operating steps are necessary in order to obtain the desired half-shell part.

From DE 198 53 130 A1 a method is furthermore known, with which partial sections of a half-shell part, in which convex as well as concave structures are both present, can be deep drawn with improved quality. For this purpose a spring-loaded slider is provided in the drawing die. In the downward movement of the drawing punch the sheet metal blank is formed in the relevant partial section first of all between the drawing punch and the corresponding surface of the slider, before the sheet metal blank is deep drawn as a whole. A material excess should in this way be prevented in specific regions. The known method only enables the shape accuracy of partial sections of the half-shell part to be improved.

On the basis of the prior art mentioned above, the object of the present invention was therefore to provide a method and a device for the process-reliable and cost-effective production of highly dimensionally stable half-shell parts. A half-shell part should also be provided from which closed or open hollow profiles can be fabricated with less effort and expense.

### BRIEF SUMMARY OF THE INVENTION

With regard to the process, this object is achieved according to a first teaching of the invention in that for the production of a half-shell part a drawing punch and a drawing die are used, and that in a single work step the drawing punch is advanced into the drawing die, a sheet metal blank is preformed to a sheet metal raw part with at least one base section, at least one frame section and optionally a flange section, wherein during the preforming with the drawing punch a material excess is introduced either into the base section and the frame section or the optional flange section of the sheet metal raw part, and the sheet metal raw part is finished so as to form a half-shell part and is calibrated.

The preforming and/or the finishing can be carried out as a cold forming step or as a hot forming step. In hot forming, sheet metal blanks of steel are normally heated at temperatures above A_{c1}, preferably above A_{c3}, and formed. In this connection a structure transformation into austenite during the heat forming is desired, in order to utilise the better forming properties of this structure, and to allow a subsequent hardening for example by transformation of the austenite into martensite or other structures.

Either in the base section and in the frame section in the production of flange-free half-shell parts, or in the optional flange section of the sheet metal raw part in the production of flanged half-shell parts, there is therefore more material than in the corresponding region of the half-shell part. This material excess can during the finishing and calibration be displaced into the other sections, which induces compression stresses in the whole half-shell part, which lie in the plastic range, and in this way the elastic recovery after deep drawing is reduced or suppressed. The method according to the invention thus leads to half-shell parts that are characterised by a high dimensional stability, i.e. very low tolerances.

In a first variant of the method the use of a drawing punch is envisaged, which comprises at least one base punch that can be positioned projecting in the direction of the drawing die, and a corresponding base punch receiver. With the base punch arranged in the projecting position, during the preforming of the sheet metal raw part the material excess is introduced either into the base section and the frame section, or into the optional flange section of the sheet metal raw part. With such an at least two-part drawing punch, during the preforming a material excess can form in the sheet metal raw part in a process reliable manner. The production of a drawing punch with a base punch that can be positioned so as to project furthermore involves only little effort and thus lower costs.

A next variant of the method envisages that the sheet metal raw part is finished by advancing the base punch into the base punch receiver as soon as the base punch has come to rest on the sheet metal raw part abutting the drawing die and is calibrated. The sheet metal raw part can thus be held by the base punch in a particularly simple manner on the drawing die, so that a slippage of the preformed sheet metal raw part can be prevented in the finishing and calibration. With the placement of the base punch on the sheet metal raw part abutting the drawing die, the material flow can furthermore be controlled in a targeted manner in a very early stage of the forming and calibration, so that a half-shell part with no elastic recovery can be produced.

The method can furthermore be developed in that the sheet metal raw part is trimmed in a single work step. The production in a single work step of a highly dimensionally stable, trimmed half-shell part allows on the one hand lower cycle times. On the other hand a single device can be used. As a result a greater economy of the method can be achieved.

Preferably the sheet metal raw part is trimmed with a cutting edge arranged on the drawing punch. The cutting edge can in this connection be formed on the drawing punch itself. Alternatively, however, a cutting plate that comprises the cutting edge can also be provided, fixed to the drawing punch and in particular also movable. By using a separate cutting plate, the fact that for example the cutting edge and the remaining regions of the drawing punch are subjected to a different degree of wear can be taken into account.

A further variant envisages that the cutting edge is brought into contact with the sheet metal raw part at the same time as the placement of the base punch on the sheet metal raw part abutting against the drawing die. The cutting edge thus comes into contact with the sheet metal raw part at a time when the preforming is largely completed. A further material flow into the drawing die or out again from the latter is then suppressed with the cutting edge. Due to the introduction of the material excess during the preforming, the cutting edge can additionally be brought into contact with a section of the sheet metal raw part that is possibly still exposed to slight tensile stresses, so that the sheet metal raw part can be separated from the scrap at an accurately defined point.

The method according to the invention can also be developed in that during the finishing and calibration, the material excess is forced from the base section of the sheet metal raw part into the frame section and/or the optional flange section of the sheet metal raw part. There thus takes place not only a displacement within the region into which the material excess was introduced during the preforming, but also in the adjoining frame section and/or the optional flange section, so that the dimensional stability of the half-shell part as a whole can be improved still further.

The dimensional stability of the half-shell part to be produced can in a further modification of the method be raised if the sheet metal part is compressed at least in a frame section, preferably also in a base section, by using a compression surface. By means of the compression the undesirable inhomogeneous stress and expansion distributions that occur in the deep drawing can be superposed and thereby purposefully aligned, so that these do not produce an unwanted elastic recovery. In particular, on account of the compression over the whole cross-sectional length half-shell parts can be produced that have a very high dimensional stability in all sections.

A compression surface adjoining the cutting edge is preferably used for this purpose, so that at the same time the cutting surface of the sheet metal raw part is smoothed with the compression surface. Then, in particular if a frame section of the sheet metal raw part is to be compressed, which for example in the production of flanged half-shell parts does not directly adjoin the cutting surface, the cutting edge and compression surface, however, can be arranged separately from one another.

A further variant of the invention envisages that the sheet metal blank is held with a hold-down device, at least at the start of the preforming. The formation of folds during the deep drawing, in particular in the case of thin sheet metal blanks, can thereby be largely avoided. Also, the material flow into the drawing die can be controlled in a targeted manner with the hold-down device.

A flange-free half-shell part is produced in a further modification of the method. Flange-free half-shell parts can be joined with an I-joint to form a closed hollow profile that does not have any interfering, projecting sections. In addition savings in weight can be achieved in this way.

Alternatively however, a flanged half-shell part can also be produced. With the flange a flat surface is made available with which the half-shell part can for example be simply welded onto flat structural parts. Furthermore, a flange can provide a sufficiently large surface for a bonding of the half-shell part to further structural elements.

According to a second teaching of the invention the object mentioned hereinbefore has been achieved by a device that comprises a drawing punch, a drawing die and means for advancing the drawing punch into the drawing die, wherein a sheet metal blank can be positioned between the drawing punch and the drawing die and the sheet metal blank can be preformed with the drawing punch to form a sheet metal raw part, wherein the drawing punch comprises means for introducing a material excess either into a base section and a frame section or an optional flange section of the sheet metal raw part, and the sheet metal raw part can be finished so as to form a half-shell part and can be calibrated. The device according to the invention thus enables a sheet metal blank to be formed in a single tool into a highly dimensional stable half-shell part, whereby considerable cost savings can be achieved. The means for introducing a material excess can be made available within the context of a device altering the shape of the drawing punch. A membrane that can be arched cambered with a pressure medium can for example be used for this purpose.

A simple first variant of the device envisages, however, a base punch that can be positioned so as to project in the direction of the drawing die, and a corresponding base punch receiver, by means of which a material excess can be introduced into the sheet metal raw part during the preforming. The production of such a drawing punch is comparatively simple, so that such a device is very cost-efficient.

A next variant of the device envisages the provision of means for trimming, in particular at least one cutting edge arranged on the drawing punch. This variant also enables the trimming to be carried out using the same device, so that further cost advantages and time savings can be gained.

The device can furthermore be configured so that the drawing die has a clearance associated with the cutting edge of the drawing punch. When trimming the sheet metal raw part the scrap can be displaced into this clearance, so that a particularly smooth cut surface can be achieved.

If according to a further variant of the device the depth of the clearance corresponds at least to the thickness of the sheet metal blank to be formed, sticking and jamming of the scrap can be prevented and the method according to the invention can be carried out in a more process-reliable manner.

A modification of the device, in which the drawing die has an in-flow contour, for example an in-flow rounded portion, facilitates the material flow into the drawing die. An in-flow contour furthermore has the advantage that it produces a self-centering of the cutting edges during the placement. Preferably the in-flow rounded portion is in this connection associated with the clearance.

A further variant of the device envisages that in the position in which the drawing punch is advanced fully into the drawing die, the cutting edge is spaced in the deep drawing direction from a counter-cutting edge arranged on the drawing die, in particular at the clearance, or is arranged at the same height.

If a pressure loading of the sheet metal raw part is to be largely avoided, the counter-cutting edge of the clearance can also be arranged at the same height as the cutting edge of the drawing punch.

In a comparable manner to the cutting edge, the counter-cutting edge can be formed on the drawing die itself or on a counter-cutting plate secured, optionally movably, to the drawing die.

With a cutting edge that is spaced in the deep drawing direction, during the finishing and calibration the sheet metal raw part located in the space between the drawing punch and the drawing die can be subjected to a pressure loading, so that the sheet metal raw part is compressed. The undesired inhomogeneous stress and expansion distributions that are present after the drawing process can be superposed in this way and converted into newly aligned stresses that suppress undesired elastic recoveries of the half-shell part, i.e. its dimensional stability can be improved. The compression carried out over the whole cross-section leads to a stress state that produces plastic flow in the whole cross-section of the half-shell part.

Another modification of the invention provides for a compression surface of the drawing punch adjoining the cutting edge. In this way the sheet metal raw part can also be purposefully compressed at the cutting surface, whereby a particularly smooth cutting surface can be achieved.

During the deep drawing the sections of the sheet metal blank forming the frame section and/or the base section of the sheet metal raw part may possibly come into contact with the counter-cutting edge. In order nevertheless to ensure a satisfactory material flow, in a further variant the counter-cutting edge can be rounded off.

With the device according to the invention and the method according to the invention half-shell parts can be produced that have a wall thickness W and in which the smooth cut proportion of the cut surfaces of the half-shell part is at least one third of the wall thickness W. Such half-shell parts can be welded at their cut surfaces particularly well in the I-joint to other structural parts.

Further advantageous properties of the device can be seen in the description of the method according to the invention.

### BRIEF DESCRIPTION OF THE DRAWINGS

The present invention is now described in more detail and illustrated with the aid of drawings showing exemplary embodiments. In the drawings:

FIGS. 1a-c show a first exemplary embodiment of a device according to the invention in various states, in cross-section;

FIG. 2 shows a perspective view of an exemplary embodiment of a half-shell part that can be produced with the devices illustrated in FIG. 1;

FIG. 3a shows the cutting edge of the half-shell part illustrated in FIG. 2 in cross-section, compared to the cutting edge of a half-shell part from the prior art illustrated in FIG. 3b;

FIGS. 4a-e show a section of a second exemplary embodiment of a device according to the invention in various states, in cross-section;

FIGS. 5a-c show a third exemplary embodiment of a device according to the invention in various states, in cross-section;

FIG. 6 shows an exemplary embodiment of a half-shell part that can be produced with a device illustrated in FIG. 5, in a perspective view;

FIGS. 7a-c show a fourth exemplary embodiment of a device according to the invention in various states, in cross-section, and

FIG. 8 shows an exemplary embodiment of a half-shell part that can be produced with the device illustrated in FIG. 7, in a perspective view.

### DETAILED DESCRIPTION OF THE INVENTION

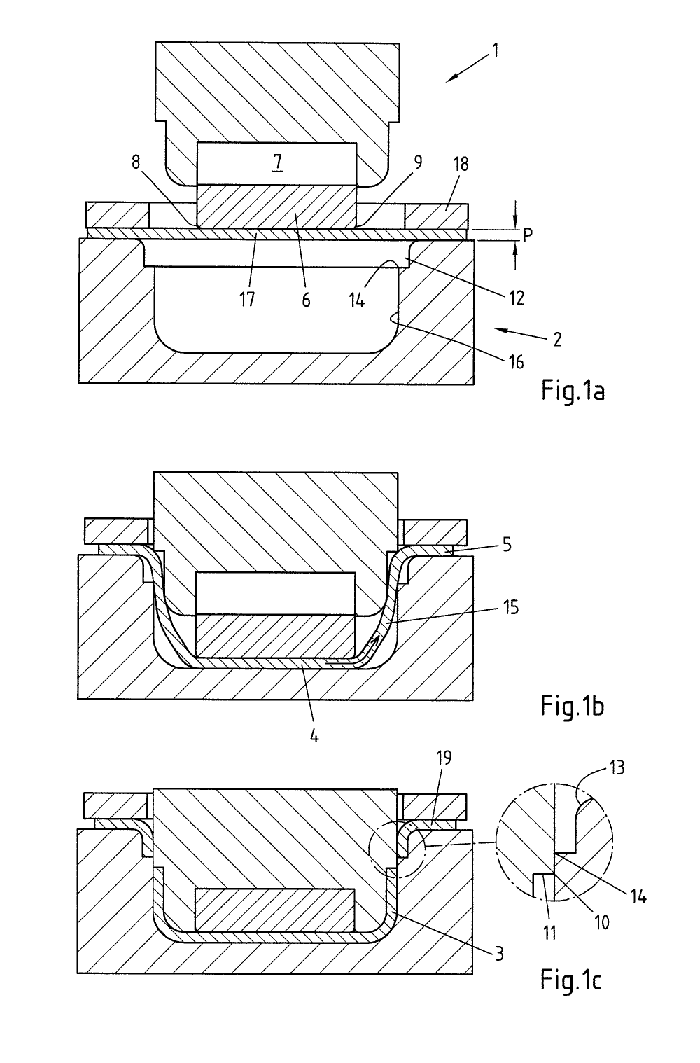

The device illustrated in FIG. 1 comprises a drawing punch 1, which can be advanced by means (not shown) into the drawing die 2, whereby it can be brought into the positions illustrated respectively in FIGS. 1a-1c so as to produce from a sheet metal blank 17 first of all a sheet metal raw part 5 and then a half-shell part 3 from the said sheet metal raw part 5.

The drawing punch 1 has means for introducing a material excess into a base section 4 of the sheet metal raw part 5. It has a shape that can be changed by a base punch 6, which is displaceably arranged in a base punch receiver 7. The edges 8 and 9 of the base punch 6 facing towards the drawing die 2 are rounded off, so that the danger of formation of kinks in the base section 4 of the sheet metal raw part 5 can be reduced.

A cutting edge 10 and a compression surface 11 directly adjoining the latter are also formed on the drawing punch 1. The compression surface 11 is in this connection aligned substantially perpendicular to the deep drawing direction, i.e. to the advancing direction of the drawing punch 1 into the drawing die 2.

The drawing die 2 has a clearance 12 with an in-flow rounded portion 13, which transforms stepwise into the drawing die frame section 16 forming the frame section 15 of the half-shell part 3 to be produced, a counter-cutting edge 14 thereby being formed. The clearance 12 is at the same time sufficiently wide and deep so that in the deep drawing the sheet metal blank 17 is not obstructed by the counter-cutting edge 14.

First of all a sheet metal blank 17 is arranged between the drawing punch 1 and the drawing die 2, corresponding to the state illustrated in FIG. 1a. The sheet metal blank 17 of thickness P is at the same time held on the drawing die 2 with a hold-down device 18. The base punch 6 is located in a position projecting in the direction of the drawing die 2 and has contact with the sheet metal blank 17.

By means of the advancing means (not shown), which may be mechanical, pneumatic or hydraulic, the drawing punch 1 and drawing die 2 are now brought into the position illustrated in FIG. 1b. The sheet metal blank 17 is thereby preformed into a sheet metal raw part 5 with a frame section 15 and a base section 4. By means of a locking device (not shown here) the base punch 6 is locked in the aforementioned position. It is, however, also conceivable to hold the base punch 6 in the projecting position for example by means of a hydraulic or pneumatic cylinder, or also by means of a spring, during the preforming.

The sheet metal blank 17 is held on the drawing die 2 by the hold-down device 18 so that on the one hand material can be drawn underneath, but on the other hand an arching of the sheet metal blank 17 and the formation of folds associated therewith is avoided.

By means of the projecting base punch 6 a sagging to the desired geometry of the base is achieved, i.e. a material excess is introduced into the base section 4 of the sheet metal raw part 5. In the region of the in-flow rounded portion 13 the sheet metal raw part 5 abuts against the clearance 12. The base punch 6 settles in the position illustrated in FIG. 1b on the sheet metal raw part 5 abutting the drawing die 2. At the same time the cutting edge 10 of the drawing punch 1 comes into contact with the sheet metal raw part 5.

In this position the locking device of the base punch 6 is now released, so that the base punch 6 is displaced into the base punch receiver 7 as the drawing punch 1 advances further into the drawing die 2. In the case of a base punch held in the projecting position with a hydraulic or pneumatic cylinder or a spring, it is sufficient that the advancing means overcome the forces exerted by cylinders or springs.

As the drawing punch 1 and drawing die 2 approach closer to an accurately defined point, local stresses are produced in the sheet metal raw part 5 by the cutting edge 10, so that a crack is formed and a trimming of the sheet metal raw part takes place. The scrap 19, i.e. the unused material of the sheet metal blank 17, is at the same time displaced into the clearance 12 of the drawing die 2.

As indicated by the arrow, at the same time the material excess produced in the preforming is forced from the base section 4 and from the frame section 15 into the whole sheet metal raw part 5. The stresses in the frame section 15 due to the deep drawing of the sheet metal blank 17 are thus purposefully aligned. The elastic recovery of a half-shell part produced with this device is therefore in any case only slight and the dimensional stability of the half-shell part is improved.

In the position illustrated in FIG. 1c the drawing punch 1 is advanced completely into the drawing die, and is in the lower dead point. The drawing punch 1 and the drawing die 2, thus, basically form a negative image of the internal and external contour of the half-shell part to be produced.

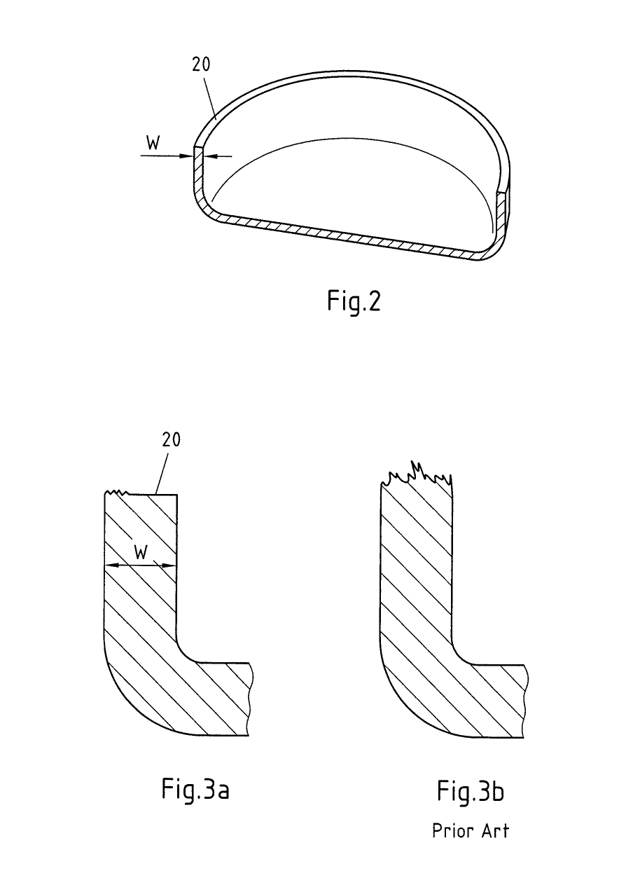

The cutting edge 10 of the drawing punch 1 is in this connection arranged in the deep drawing direction spaced from the counter-cutting edge 14 associated with the drawing die 2. In this way the frame section 15 can be compressed in the course of the finishing and calibration. This also contributes to the high dimensional stability of the finished flange-free half-shell part 3 illustrated in FIG. 2, which is characterised in particular by a relatively smooth cut surface 20.

With regard to the wall thickness W of the half-shell part 3 according to the invention, the smooth cut proportion of the cut surface 20, as diagrammatically illustrated in FIG. 3a, is more than one third compared to a half-shell part from the prior art (FIG. 3b). Consequently, the illustrated half-shell part 3 can be welded in a particularly simple manner to further structural elements, in particular also to a half-shell part produced with a comparable device, in the I-joint so as to form a closed hollow shell profile.

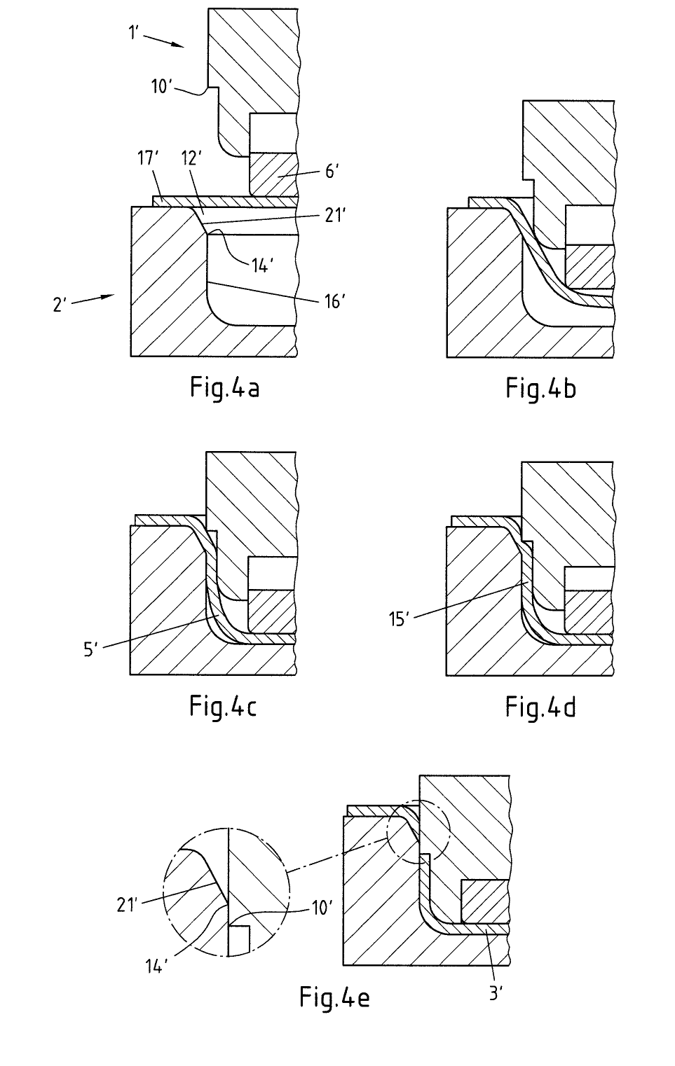

FIG. 4 shows a section of an alternative embodiment of a device for producing a flange-free half-shell part 3′. This likewise comprises a drawing punch 1′ with a base punch 6′ and a drawing die 2′. The clearance 12′ is however not stepped, but transforms with an inclined surface 21′ into the drawing die frame section 16′.

The inclined surface 21′ has compared to the stepped transition the advantage that a counter-cut edge 14′ with a more obtuse angle is formed. Its wear can thereby be reduced. Furthermore, it can be manufactured more simply. On the other hand a stepped transition offers less resistance to displaced scrap during the trimming and reduces the danger of a blockage of the scrap in the device. Moreover, the inclined surface 21′ produces a self-centering of the cut edge 10′ during the trimming.

As in the device illustrated in FIG. 1, the cut edge 10′ in the position of the drawing punch 1′ advanced completely into the drawing die 2′ is, moreover, located deeper in the drawing direction than the counter-cut edge 14′ (see FIG. 4e). Consequently, in the device illustrated in FIG. 4 the whole cross-section of the half-shell part 3′ is compressed and converted into a plastic state.

A clearance that has an inclined surface, as well as a stepped clearance, can be combined with an arrangement of the cutting edge and the counter-cutting edge, in which the cutting edge and counter-cutting edge in the position of the drawing punch fully advanced into the drawing die, are at least at the same height.

With regard to the sequence of the forming procedure from the sheet metal blank 17′ via a sheet metal raw part 5′ to a half-shell part 3′, reference is made to the explanations given regarding FIG. 1.

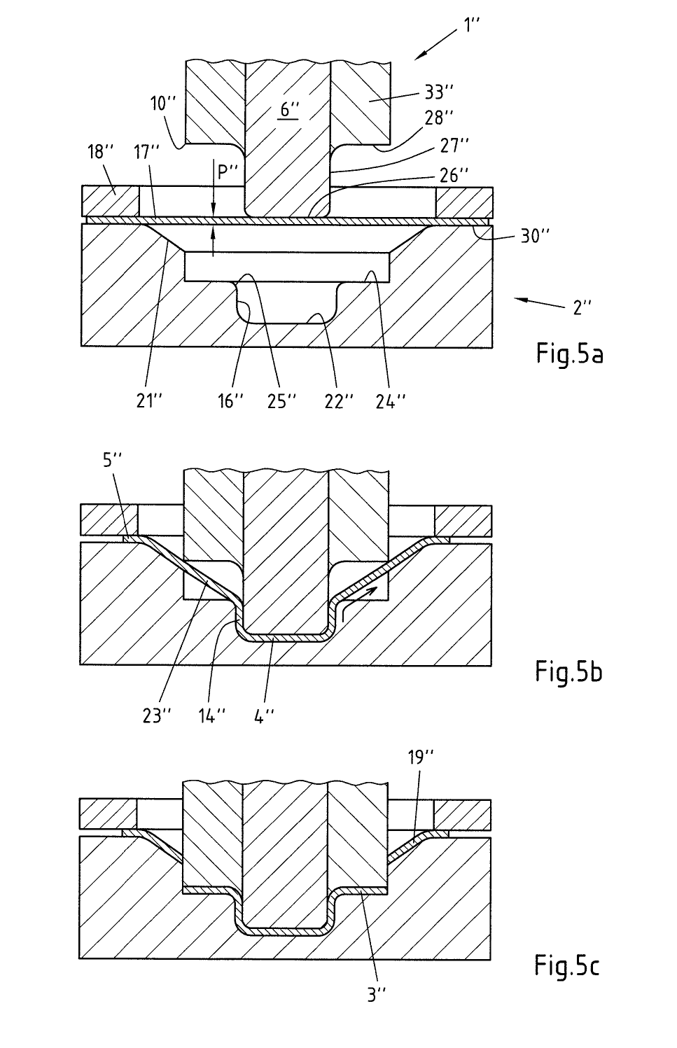

Finally, FIG. 5 shows an embodiment of a device according to the invention with which a flanged half-shell part 3″ can be produced. Corresponding to the devices described hereinbefore, the device illustrated in FIG. 5 likewise comprises a drawing punch 1″ with a base punch 6″, which additionally includes a flange-forming punch 33″.

The drawing die 2″ comprises a drawing die base section 22″ forming the base section 4″ of the sheet metal raw part 5″, a drawing die frame section 16″ forming the frame section 14″ of the sheet metal raw part 5″, and a drawing die flange section 24″ forming the flange section 23″ of the sheet metal raw part 5″. The transition 25″ from the drawing die flange section 24″ to the drawing die frame section 16″ comprises in this connection an in-flow rounded portion and a drawing radius.

In a corresponding manner the base punch 6″ comprises a base section 26″ and a base punch frame section 27″, and the flange-forming punch 33″ comprises a flange-forming punch section 28″ with a cutting edge 10″. An inclined surface 21″, shown enlarged, is associated with this cutting edge 10″ on the side of the drawing die 2″, and allows the self-centering of the cutting edge 10″.

To produce the flanged half-shell part 3″, the sheet metal blank 17″ is first of all arranged between the drawing punch 1″ and the drawing die 2″, as shown in FIG. 5a. The base punch 6″ of the drawing punch 1″ is then in a position projecting in the direction of the drawing die 2″. The sheet metal blank 17″ is held on the drawing die 2″ by a hold-down device 18″ outside the drawing die flange section 24″. The counter-holding section 30″ of the drawing die 2″, held against the sheet metal blank 17″ by the hold-down device 18″, is at the same time spaced further from the drawing die base section 22″ compared to the drawing die flange section 24″.

By advancing the drawing punch 1″ into the drawing die 2″ a sheet metal raw part 5″ is first of all formed, a material excess being produced in the flange section 23″ of the sheet metal raw part 5″ (see FIG. 5b). The flange section 23″ of the sheet metal raw part 5″ experiences, due to the displaced planes of the drawing punch flange section 24″ and counter-holding section 30″, a convex bending as well as a concave bending when the sheet metal blank is drawn.

At the same time as the placement of the base punch 6″ on the sheet metal raw part 5″ abutting against the drawing die base section 22″, the cutting edge 10″ comes into contact with the sheet metal raw part 5″.

After the placement of the base punch 6″ on the sheet metal raw part 5″, only the flange forming punch 33′ still moves in the direction of the drawing die 2″, and the sheet metal raw part 5″ is trimmed with the cutting edge 10″ to form a flanged half-shell part 3″, and finished and calibrated.

In the position in which the drawing punch 1″ has advanced fully into the drawing die 2″ as illustrated in FIG. 5c, it can be seen that the flange-forming punch section 28″ is formed as an offset contour of the drawing punch flange section 24″. The offset has the thickness P″ of the sheet metal blank 17″, so that it is compressed by the excess material of the flange section 23″. The offset between the drawing punch base section 26″ and the drawing die base section 22″ corresponds to the thickness P″ of the sheet metal blank 17″. Between the drawing die frame section 16″ and the drawing punch frame section 27″ the offset is increased by a drawing gap, not shown in FIGS. 5a-c, so as to allow a material flow between the different sections of the sheet metal raw part 5″ during the finishing and calibration.

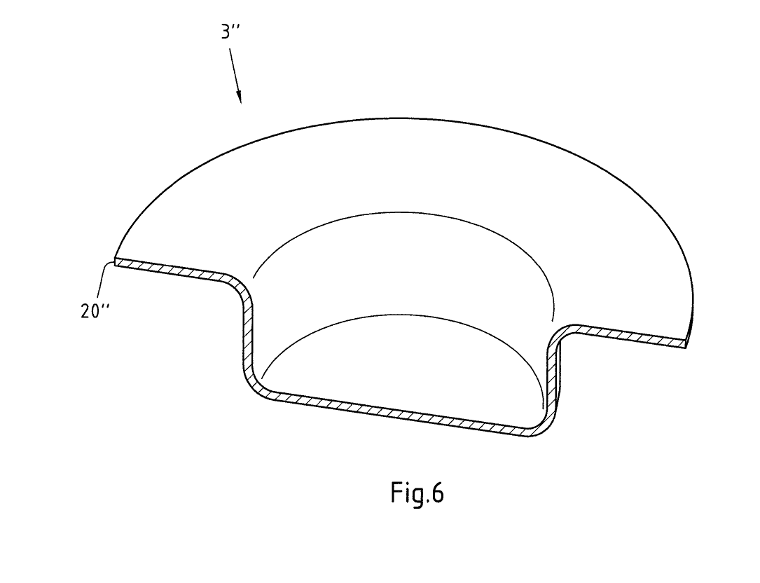

A highly dimensionally stable, trimmed half-shell part 3″ can thus for example be produced with the device, and is shown in a perspective view in FIG. 6.

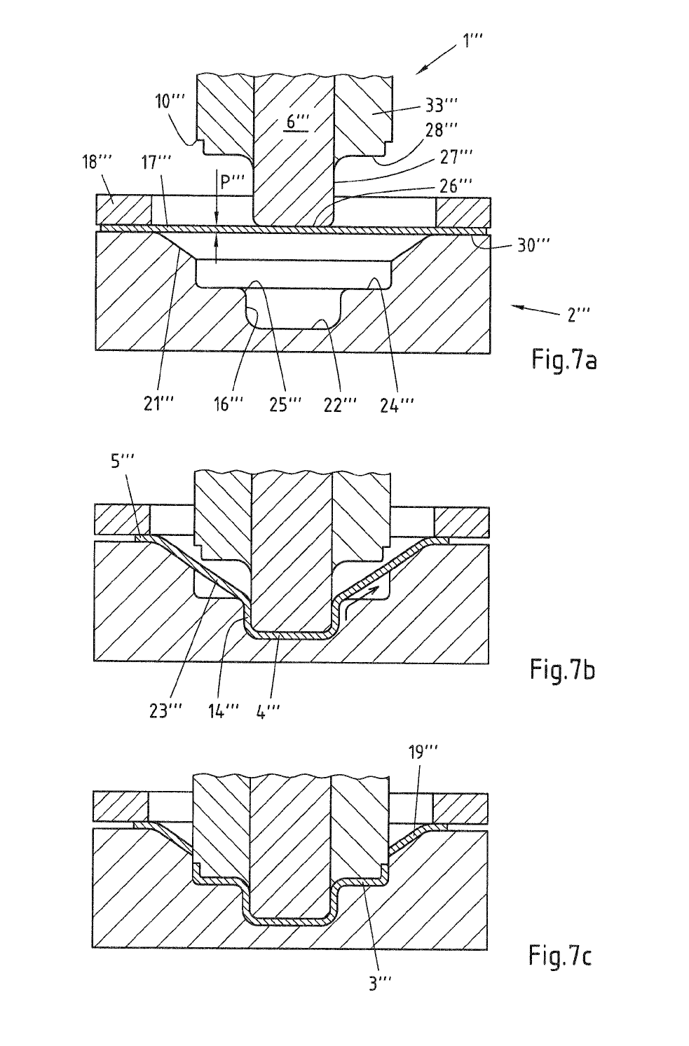

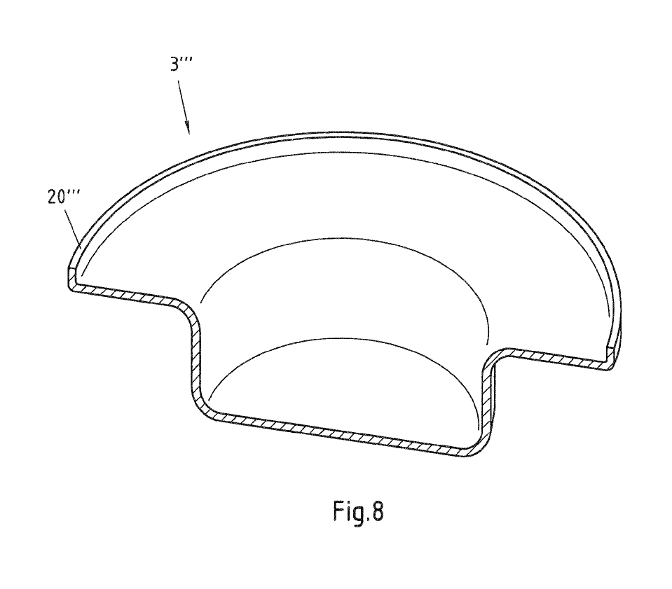

FIG. 7 shows a further variant of an embodiment of a device according to the invention, with which a further shape of a flange-free half-shell part 3′″ can be produced, as shown in a perspective view in FIG. 8.

The only difference compared to the device illustrated in FIGS. 5a-c is that the flange-forming punch 33′″ has on the side a recess with a cutting edge 10′″, so that after the trimming of the sheet metal raw part 5′″ and due to the further advance of the device, the end section of the sheet metal raw part 5′″ is converted into the recess. The flange-free half-shell part 3′″ is finished and calibrated.

The high dimensional stability of the flange-free or flanged half-shell parts 3, 3′, 3″, 3′″ is promoted by the fact that, due to the compression, the whole cross-section is converted into a plastic state and stresses can thereby be aligned in a targeted manner.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Method for producing a half-shell part with a drawing punch and a drawing die, wherein a single work step the drawing punch is advanced into the drawing die, a sheet metal blank is preformed into a sheet metal raw part with at least one base section, at least one frame section and optionally a flange section, wherein during the preforming with the drawing punch a material excess is introduced either into the base section and the frame section or the optional flange section of the sheet metal raw part, and the sheet metal raw part is finished to form a half-shell part and is calibrated, wherein the sheet metal raw part is trimmed in the single work step, preferably using a cutting edge arranged on the drawing punch.

2. Method according to claim 1, wherein a drawing punch is used, which comprises at least one base punch that can be positioned projecting in the direction of the drawing die, and with the base punch arranged in the projecting position the material excess is introduced during the preforming of the sheet metal raw part into the base section and the frame section and/or the optional flange section of the sheet metal raw part.

3. Method according to claim 1, wherein the sheet metal raw part is finished by advancing the base punch into the base punch receiver as soon as the base punch has come to rest on the sheet metal raw part abutting the drawing die, and is calibrated.

4. Method according to claim 2, wherein the cutting edge is, at the same time as the placement of the base punch on the sheet metal raw part abutting against the drawing die, brought into contact with the sheet metal raw part.

5. Method according to claim 1, wherein during the finishing and calibration the material excess is forced from the base section of the sheet metal raw part into the frame section of the sheet metal raw part.

6. Method according to claim 1, wherein the sheet metal raw part is compressed using a compression surface, in particular using a compression surface abutting against the cutting edge, at least in a frame section, preferably also in a base section.

7. Method according to claim 1, wherein the sheet metal blank is held at least at the start of the preforming with a hold-down device.

8. Method according to claim 1, wherein a flange-free half-shell part or a flanged half-shell part is produced from the sheet metal raw part.

9. Device for producing a half-shell part with a method according to claim 1, with a drawing punch and a drawing die, wherein the device comprises means for advancing the drawing punch into the drawing die, a sheet metal blank can be positioned between the drawing punch and the drawing die, the sheet metal blank can be preformed with the drawing punch into a sheet metal raw part, the drawing punch comprises means for introducing a material excess either into a base section and a frame section or an optional flange section of the sheet metal raw part, and the sheet metal raw part can finished with the drawing punch to form a half-shell part and calibrated, wherein means are provided for trimming, in particular at least one cutting edge arranged on the drawing punch.

10. Device according to claim 9, wherein the drawing punch has at least one base punch that can be positioned projecting in the direction of the drawing die, and optionally has a corresponding base punch receiver.

11. Device according to claim 9, wherein the drawing die has at least one clearance associated with the cutting edge of the drawing punch.

12. Device according to claim 11, wherein the depth of the clearance corresponds at least to the sheet metal blank thickness of the sheet metal blank to be formed.

13. Device according to claim 11, wherein the drawing die has an in-flow rounded portion, in particular an in-flow rounded portion arranged on the clearance.

14. Device according to claim 11, characterised in that the cutting edge in the position in which the drawing punch is advanced fully into the drawing die is arranged in the deep drawing direction spaced from a counter-cutting edge arranged on the drawing die, in particular on the clearance, or is arranged at least at the same height as the counter-cutting edge.

15. Device according to claim 14, wherein the counter-cutting edge is rounded off.

16. Device according to claim 9, wherein the drawing punch comprises a compression surface, in particular a compression surface directly adjoining the cutting edge.

17. Half-shell part produced by a method according to claim 1, wherein the half-shell part has a wall thickness W and a smooth cut fraction of cut surfaces of the half-shell part is at least one third of the wall thickness W.
